(19) United States
(12) Patent Application Publication
(10) Pub. No.: US 2010/0067011 A1
(43) Pub. Date: Mar. 18, 2010

(54) AMBIENT LIGHT REDUCTION FOR OPTICAL TOMOGRAPHY

(75) Inventor: Levinus Pieter Bakker, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/447,675

(22) PCT Filed: Oct. 25, 2007
(86) PCT No.: PCT/IB2007/054346

§ 371 Date: Apr. 29, 2009

(30) Foreign Application Priority Data
Nov. 2, 2006 (EP) 06123377.1

(51) Int. Cl. G01N 21/00

(52) U.S. Cl. 356/432

(57) ABSTRACT

The invention relates to an adaptation medium (100) for use in a device (45) for imaging an interior of a turbid medium (90), the device (45) for imaging an interior of a turbid medium (90) comprising: a. a receiving volume (60) for accommodating the turbid medium (90); b. an irradiation light source (50) for irradiating the turbid medium (90); c. a photodetector unit (55) for detecting light emanating from the receiving volume (60) as a result of irradiating the turbid medium (90). The invention also relates to a device (45) for imaging an interior of a turbid medium (90) and to a medical image acquisition device, the device (45) for imaging an interior of a turbid medium (90) and the medical image acquisition device comprising: a. a receiving volume (60) for accommodating a turbid medium (90); b. an irradiation light source (50) for irradiating the turbid medium (90); c. a photodetector unit (55) for detecting light emanating from the receiving volume (60) as a result of irradiating the turbid medium (90). It is an object of the invention to reduce the effect on a measurement of light from a light source other than the irradiation light source (50). According to the invention this object is achieved in that the adaptation medium (100) comprises filtering means, such as a dye, for filtering out light from a light source other than the irradiation light source (50).

### FIELD OF THE INVENTION

The invention relates to an adaptation medium for use in a device for imaging an interior of a turbid medium, the device for imaging an interior of a turbid medium comprising:
a. a receiving volume for accommodating a turbid medium;
b. an irradiation light source for irradiating the turbid medium;
c. a photodetector unit for detecting light emanating from the receiving volume as a result of irradiating the turbid medium.

The invention also relates to a device for imaging an interior of a turbid medium, comprising:
a. a receiving volume for accommodating a turbid medium;
b. an irradiation light source for irradiating the turbid medium;
c. a photodetector unit for detecting light emanating from the receiving volume as a result of irradiating the turbid medium.

The invention also relates to a medical image acquisition device comprising:
a. a receiving volume for accommodating a turbid medium;
b. an irradiation light source for irradiating the turbid medium;
c. a photodetector unit for detecting light emanating from the receiving volume as a result of irradiating the turbid medium.

### BACKGROUND OF THE INVENTION

An embodiment of an adaptation medium of this kind is known from U.S. Pat. No. 5,907,406. The known adaptation medium can be used for imaging an interior of a turbid medium, such as biological tissue, using diffuse optical tomography. In medical diagnostics the adaptation medium may be used for imaging an interior of a female breast. In that case, at least a part of a turbid medium, such as a female breast, is accommodated in a receiving volume. Inside the receiving volume, the turbid medium is surrounded by the adaptation medium. Light from an irradiation light source is coupled into the receiving volume and hence into the turbid medium. Light emanating from the turbid medium as a result of coupling light into the receiving volume is coupled out of the receiving volume. Light coupled out of the receiving volume is used to reconstruct an image of an interior of the turbid medium. The adaptation medium is chosen such that the optical parameters of the adaptation medium are substantially identical to the optical parameters of the turbid medium. In this way, image artefacts resulting from optical boundary effects that occur when light is coupled into and out of the turbid medium can be reduced.

It is a characteristic of the kind of measurement described above that the level of light emanating from the receiving volume can be very low and hence that this kind of measurement is sensitive to light coming from a light source other than the irradiation light source. An example of light coming from a light source other than the irradiation light source may be ambient light present in the room in which a measurement is performed and that is able to enter the receiving volume.

### SUMMARY OF THE INVENTION

It is an object of the invention to reduce the effect on a measurement of light from a light source other than the irradiation light source.

According to the invention this object is achieved in that the adaptation medium comprises a filter for filtering out light from a light source other than the irradiation light source.

The invention is based on the recognition that an adaptation medium comprised in the receiving volume for the turbid medium presents a ‘point of attack’ for filtering out light from a light source other than the irradiation light source that has entered the receiving volume.
It is an additional advantage of the invention that an adaptation medium comprising a filter eliminates the need to use a ‘traditional’ filter somewhere in the optical path between the turbid medium and the photodetector unit. Such a ‘traditional’ filter has the drawback that, in addition to rejecting undesired signals, it also rejects a part of the desired measurement signal.

An embodiment of the adaptation medium according to the invention is characterized in that the filter is chosen such that it absorbs light from a light source other than the irradiation light source. This embodiment has the advantage that it is easy to implement, especially in a liquid adaptation medium, by adding a suitable absorbing substance to the adaptation medium. If the invention is used in a device for imaging an interior of the female breast, as may be done in medical diagnostics, the essential feature of a suitable absorbing substance is that this substance does not substantially absorb light in the wavelength range used for imaging an interior of the breast, but does absorb light outside this wavelength range. For imaging an interior of a female breast, light in the wavelength range of 650 to 1400 nm is used. Therefore, it is essential for an absorbing substance to be suitable that the substance does not substantially absorb light in this wavelength range, but does absorb light within the wavelength range of 400 to 650 nm. This latter wavelength range comprises the visible part of the electromagnetic spectrum. Light from this part of the spectrum may interfere with a measurement if, for instance, ambient light present in the room where the device is located is able to enter the receiving volume. Examples of suitable absorbing substances are Fast Green FCF, Brilliant black BN, Green S, and Ammonium Ferric citrate green or a combination of at least two suitable absorbing substances.

A further embodiment of the adaptation medium according to the invention is characterized in that the filter is chosen such that it scatters light from a light source other than the irradiation light source. Introducing a filter that scatters light from a light source other than the irradiation light source results in the path followed by light from a light source other than the irradiation light source inside an adaptation medium according to the invention to be longer as compared to the length of the path traveled in an adaptation medium that does not comprise the invention. Increasing the length of the path traveled inside an adaptation medium by light from a light source other than the irradiation light source increases the chance that this light is absorbed inside the adaptation medium as this chance depends on the length of the path traveled. An example of a suitable scattering substance is titanium dioxide finely dispersed within the adaptation medium. In medical diagnostics the known adaptation medium already comprises titanium dioxide particles to scatter light that is used during a measurement. However, according to this embodiment the adaptation medium comprises a scattering substance, such as titanium dioxide, the size of the titanium dioxide particles being chosen such that the particles scatter light from a light source other than the irradiation light source, but do not substantially scatter light that is used during a measurement. In medical diagnostics, light in the wavelength range of 600 nm to 1400 nm is typically used to image an interior of, for instance, the female breast. Through the use of titanium dioxide particles having a characteristic size of, for instance, 100 nm a situation can be created in which light having a wavelength in the wavelength range that is used during a measurement, for instance the range of 600 nm to 1000 nm that is typically used to image an interior of, for instance, a female breast, is not substantially scattered, whereas light having a shorter wavelength than the light that is used during a measurement experiences substantial scattering.

The object of the invention is further achieved by means of a device for imaging an interior of a turbid medium, comprising:
a. a receiving volume for accommodating a turbid medium;
b. an irradiation light source for irradiating the turbid medium;
c. a photodetector unit for detecting light emanating from the receiving volume as a result of irradiating the turbid medium;
d. an adaptation medium according to any one of the embodiments of the adaptation medium according to the invention. A device for imaging an interior of a turbid medium benefits from any of the previous embodiments.

The object of the invention is further achieved by means of a medical image acquisition device for imaging an interior of a turbid medium, comprising:
a. a receiving volume for accommodating a turbid medium;
b. an irradiation light source for irradiating the turbid medium;
c. a photodetector unit for detecting light emanating from the receiving volume as a result of irradiating the turbid medium;
d. an adaptation medium according to any one of the embodiments of the adaptation medium according to the invention. A medical image acquisition device that may be used for, for instance, imaging an interior of a female breast benefits from any of the previous embodiments.

### BRIEF DESCRIPTION OF THE DRAWINGS

These and other aspects of the invention will be further elucidated and described with reference to the drawings, in which:

FIG. 1 schematically shows an embodiment of a device for imaging an interior of a turbid medium according to the invention;

FIG. 2 schematically shows an embodiment of a medical image acquisition device according to the invention;

FIG. 3 shows an idealized absorption characteristic of a substance suitable as a means for filtering out light from a light source other than the irradiation light source in a device for imaging an interior of a turbid medium as well as a medical image acquisition device according to the invention.

### DETAILED DESCRIPTION OF EMBODIMENTS

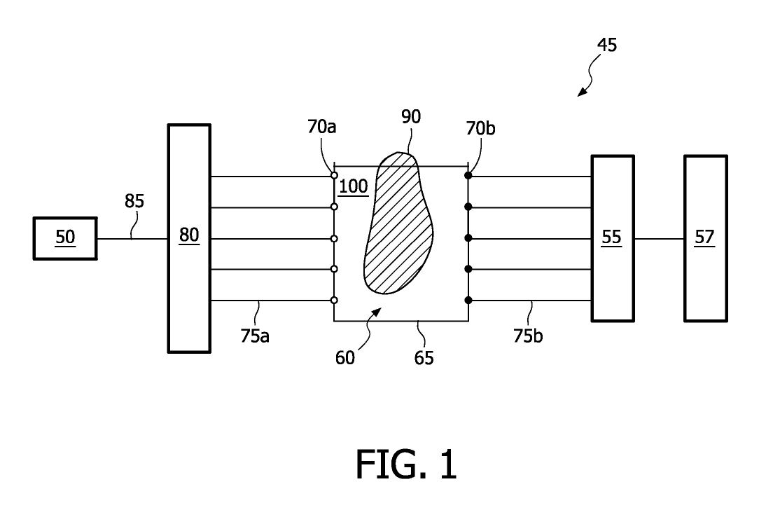

FIG. 1 schematically shows an embodiment of a device for imaging an interior of a turbid medium according to the invention. The device 45 comprises an irradiation light source 50, a photodetector unit 55, an image reconstruction unit 57 for reconstructing an image of an interior of a turbid medium 90 based on light detected using the photodetector unit 55, a receiving volume 60 bound by a receptacle 65, said receptacle comprising a plurality of entrance positions for light and exit positions for light 70a and 70b, respectively, and light guides 75a and 75b coupled to said entrance positions and exit positions. The device 45 further includes a selection unit 80 for coupling the input light guide 85 to a number of entrance positions selected from the plurality of entrance positions 70a in the receptacle 65. For the sake of clarity, entrance positions 70a and exit positions 70b have been positioned at opposite sides of the receptacle 65. In reality, however, both entrance positions and exit positions may be distributed around the receiving volume 60. The turbid medium 90 is placed inside the receiving volume 60. The turbid medium 90 is then irradiated with light from the light source 50 from a plurality of positions by coupling the light source 50 to successively selected entrance positions 70a, using the selection unit 80. The light is chosen such that it is capable of propagating through the turbid medium 90. If, as may be the case in medical diagnostics, the device 45 is used for imaging an interior of a female breast, suitable light is, for instance, laser light with a wavelength within the range of 650 nm to 1000 nm. Light emanating from the receiving volume 60 as a result of irradiating the turbid medium 90 is detected from a plurality of exit positions, using exit positions 70b and using photodetector unit 55. The detected light is then used to derive an image of an interior of the turbid medium 90. Deriving an image of an interior of the turbid medium 90, based on the detected light, is possible as at least part of this light has traveled through the turbid medium 90 and, as a consequence, contains information relating to an interior of the turbid medium 90. At least a part of the volume inside the receiving volume 60 that is not occupied by the turbid medium 90 is filled with an optical adaptation medium 100 that has optical properties that are similar to those of the turbid medium 90. The adaptation medium 100 is used to reduce the effect on the image reconstruction process of optical boundary effects occurring as a result of coupling light from the light source 50 into and out of the turbid medium 90. According to the invention the adaptation medium 100 comprises filtering means for filtering out light from a light source other than the light source 50. Ambient light present in the room where the device 45 is located may be such a secondary light source. According to one embodiment of the invention the adaptation medium 100 comprises filtering means arranged for absorbing light from a secondary light source. Light from a secondary light source, such as ambient light, enters the receiving volume and is, at least partially, absorbed by the adaptation medium 100. Hence, the amount of light from the secondary light source that is detected is reduced. Dyes such as Fast Green FCF, Brilliant black BN, Green S, and Ammonium Ferric citrate green, or a mixture of at least two of such substances, are suitable filtering means for use in an adaptation medium 100. Commercially available filtering means have the advantage that they are easy to obtain. It will be clear that the light emitted by the secondary light source preferably contains as little light as possible in the wavelength range that is used during a measurement. If, for instance, the secondary light source is a light source illuminating the room where the device 45 is located, this secondary light source is preferably arranged such that it emits as little light as possible in the wavelength range used for a measurement. In medical diagnostics, where the device 45 may be used for imaging, for example, an interior of a female breast, the wavelength range of 650 nm to 1400 nm is suitable for imaging. Arranging a secondary light source such that it emits as little light as possible in the wavelength range used for a measurement can be achieved by placing a light filter, such as a lamp shade filtering out light in the wavelength range used for a measurement, around the light source. In FIG. 1 the receiving volume 60 is bound by a receptacle 65. However, this need not always be the case. Another embodiment of a device for imaging an interior of a turbid medium is that of a handheld device that may, for instance, be pressed against a side of a turbid medium. In that case, the receiving volume is the volume occupied by the part of the turbid medium from which light is detected as a result of irradiating the turbid medium.

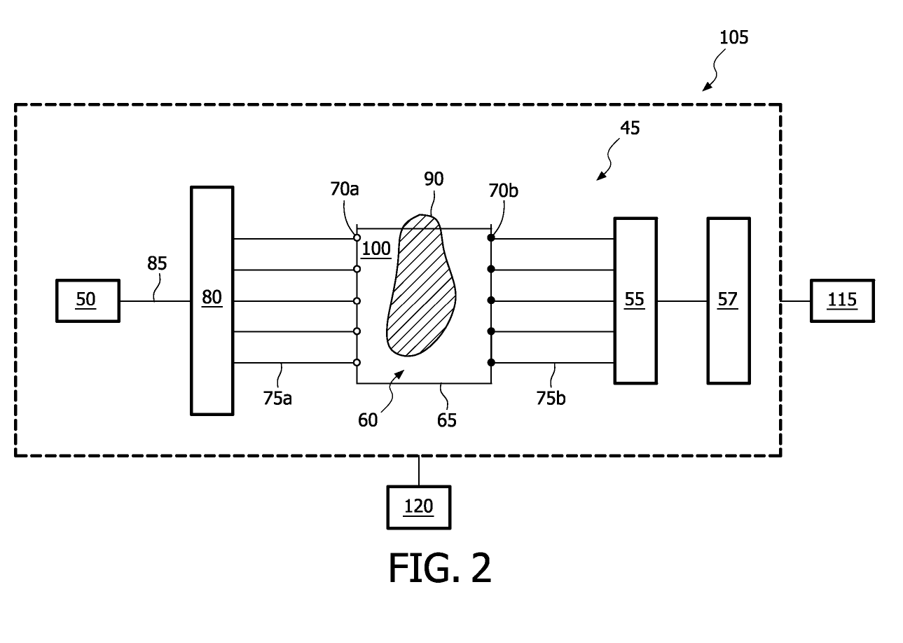

FIG. 2 schematically shows an embodiment of a medical image acquisition device according to the invention. The medical image acquisition device 105 comprises the device 45 discussed in FIG. 1, as indicated by the dashed square. The medical image acquisition device 105 further comprises a screen 115 for displaying an image of an interior of the turbid medium 90 and an input interface 120, for instance, a keyboard enabling an operator to interact with the medical image acquisition device 105.

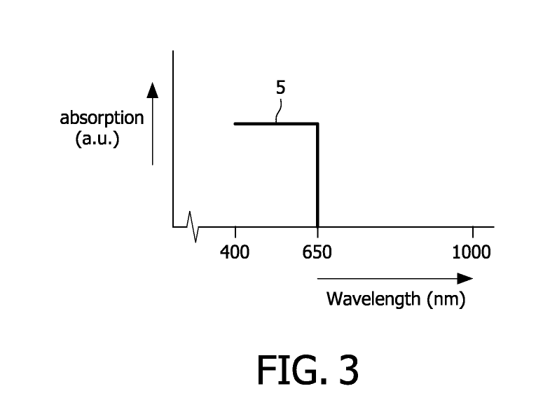

FIG. 3 shows an idealized absorption characteristic of a substance suitable as a means for filtering out light from a light source other than the irradiation light source in a device 45 (see FIG. 1) for imaging an interior of a turbid medium as well as a medical image acquisition device 105 (see FIG. 2) according to the invention. Plotted along the horizontal axis is the wavelength in nanometers. Plotted along the vertical axis is the absorption in arbitrary units. The absorption characteristic is illustrated by curve 5. In the idealized situation of FIG. 3, curve 5 shows no absorption within the wavelength range of 650 nm to 1000 nm. In reality, some absorption will be virtually unavoidable. As discussed in relation to FIG. 1, the wavelength range of 650 nm to 1000 nm is used in medical diagnostics to image an interior of a female breast in a device like the device 45 discussed in FIG. 1. Therefore, absorption of light in this wavelength range is undesirable. Absorption of other wavelengths is relatively strong in curve 5. Hence, the amount of light from light sources other than the irradiation light source 50 emanating from the receiving volume 60 comprised in a device 45 for imaging an interior of a turbid medium 90 or a medical image acquisition device 105 is reduced through the use of an adaptation medium 100 comprising a substance or a mixture of substances having an absorption characteristic similar to that of Fast Green FCF.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of computer readable software or hardware. The mere fact that certain measures are recited in mutually different dependent claims does not indicate that a combination of these measures cannot be used to advantage.

1. An adaptation medium (100) for use in a device (45) for imaging an interior of a turbid medium (90), the device (45) for imaging an interior of a turbid medium (90) comprising:
a. a receiving volume (60) for accommodating a turbid medium (90);
b. an irradiation light source (50) for irradiating the turbid medium (90);
c. a photodetector unit (55) for detecting light emanating from the receiving volume (60) as a result of irradiating the turbid medium (90);
and the adaptation medium (100) comprising a filter for filtering out light from a light source other than the irradiation light source (50).

2. An adaptation medium (100) as claimed in claim 1, wherein the filter is chosen such that it absorbs light from a light source other than the irradiation light source (50).

3. An adaptation medium (100) as claimed in claim 1, wherein the filter is chosen such that it scatters light from a light source other than the irradiation light source (50).

4. A device (45) for imaging an interior of a turbid medium (90), comprising:
a. a receiving volume (60) for accommodating a turbid medium (90);
b. an irradiation light source (50) for irradiating the turbid medium (90);
c. a photodetector unit (55) for detecting light emanating from the receiving volume (60) as a result of irradiating the turbid medium (90);
d. an adaptation medium (100) according to claim 1.

5. A medical image acquisition device (105) for imaging an interior of a turbid medium (90), comprising:
a. a receiving volume (60) for accommodating a turbid medium (90);
b. an irradiation light source (50) for irradiating the turbid medium (90);
c. a photodetector unit (55) for detecting light emanating from the receiving volume (60) as a result of irradiating the turbid medium (90);
d. an adaptation medium (100) according to claim 1.
